(19) United States
(12) Patent Application Publication
(10) Pub. No.: US 2003/0237094 A1
(43) Pub. Date: Dec. 25, 2003

(54) Method to compare various initial cluster sets to determine the best initial set for clustering a set of TV shows

(75) Inventors: Kaushal Kurapati, Yorktown Heights, NY (US); Srinivas Gutta, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/179,313

(22) Filed: Jun. 24, 2002

(51) Int. Cl. H04N 5/445

(52) U.S. Cl. 725/46

(57) ABSTRACT

Possible initial cluster sets for a clustering process deriving stereotypes from a sample population of viewing histories are compared by computing, for each candidate initial cluster set, a metric relating to the distance of each cluster within the candidate initial cluster set to every other cluster within the candidate initial cluster set. The metric, which is preferably a normalized average aggregate of the distances between clusters within a candidate initial cluster set, is then utilized to discard inferior candidates having clusters that are too close to each other.

### TECHNICAL FIELD OF THE INVENTION

The present invention is directed, in general, to formation of stereotypes as initial user profiles for recommendation systems and, more specifically, to selection of initial clusters for formulation of stereotypes by clustering.

### BACKGROUND OF THE INVENTION

Systems employed in generating guides, or information regarding available options in connection with a particular activity, may produce suggestions or recommendations for the user. Examples of such systems include on-line shopping or information retrieval systems and systems for delivery of content, particularly entertainment content such as audio or video programs, games and the like. In the case of systems delivering entertainment content, automatic action may be triggered by the generation of a suggestion or recommendation, such as caching, during a period when the entertainment content is not being utilized by the user, at least a portion of available entertainment content for later presentation to the user.

In generating suggestions or recommendations, suitable results are most often obtained by employing, at least in part, an explicit user profile of likes and dislikes. In general, such explicit user profiles are generated by user access and completion of a profiling questionnaire, within which the user rates various meta-data descriptors such as (for video content) genre, actor(s), director, title, etc.

Populating or developing an explicit user profile typically must be initiated by the user, and often requires (or allows) users to independently enter values for meta-data descriptors, such as an actor's name or the title of video content. This forces the user to attempt to remember, at the time of profile creation, all relevant values for meta-data descriptors on which actions employing the profile should be based, which is difficult if not impossible.

On the other hand, displaying a list of all possible meta-data descriptor values to the user, from which selections may be made to populate the user's profile, will generally result in the user having to review a list of unwieldy size, or risk missing suitable descriptors. Particularly for cross-media systems (i.e., video, audio and/or other content), the user might be required to select and/or rate items from a list containing tens of thousands of entries. Either alternative (requiring the user to recall relevant items or presenting the user with a comprehensive list), or even a combination of the two approaches, is unduly demanding on the user and requires more time than a user is likely to be willing to spend on the task, and is therefore unsatisfactory.

A quick and effective technique for initializing a user profile involves stereotypes derived from analysis of the viewing patterns of a multitude of users. The user selects a stereotype or set of stereotypes to initialize the profile, and thereafter provides feedback to the system in order to customize the user profile.

Stereotypes may be formulated from the viewing patterns or histories of a group of users by a clustering algorithm. However, the quality of the stereotypes so derived is dependent on the initial sets of clusters employed. The further apart the initial clusters are, the better the chance that the clustering process will be stable and will not result in empty clusters.

There is, therefore, a need in the art for a system and process insuring initial cluster quality in generating stereotypes for initializing profiles within a recommendation system.

### SUMMARY OF THE INVENTION

To address the above-discussed deficiencies of the prior art, it is a primary object of the present invention to provide, for use in a system deriving stereotypes from a sample population of viewing histories utilizing a clustering process, comparison of possible initial cluster sets for the clustering process based a metric computed for each candidate initial cluster set and relating to the distance of each cluster within the candidate initial cluster set to every other cluster within the candidate initial cluster set. The metric, which is preferably a normalized average aggregate of the distances between clusters within a candidate initial cluster set, is then utilized to discard inferior candidates having clusters that are too close to each other.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a system for formulating and delivering stereotype for initializing recommendation system user profiles according to one embodiment of the present invention;

FIG. 2 depicts in greater detail a system controller implementing stereotype formulation according to one embodiment of the present invention; and

FIG. 3 is a high level flowchart for a process of selecting one or more possible initial cluster sets for a clustering process deriving stereotypes from a sample population of viewing histories according to one embodiment of the present invention.

### DETAILED DESCRIPTION OF THE INVENTION

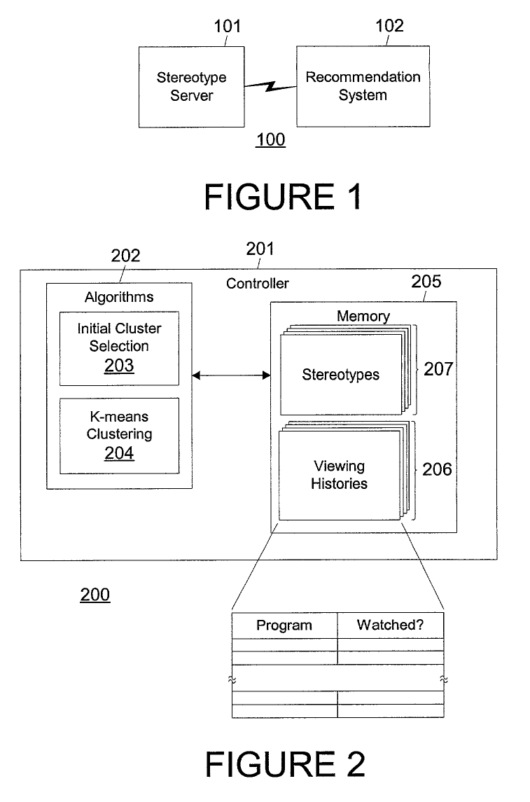

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a system for formulating and delivering stereotype for initializing recommendation system user profiles according to one embodiment of the present invention. Exemplary system 100 includes a stereotype server 101 formulating and delivering stereotypes for use in initializing recommendation systems communicably coupled to a recommendation system 102. Recommendation system may be implemented, for instance, within a video program receiver, an audio receiver, or an Internet access device such as a set-top box or computer.

Those skilled in the art will recognize that the full construction and operation of a system for formulating stereotypes is not depicted or described herein. Instead, for simplicity and clarity, only so much of the construction and operation of the system as is unique to the present invention or necessary for an understanding of the present invention is depicted and described. The remainder of the construction and operation of the system may conform to conventional structures or practices known in the art.

FIG. 2 depicts in greater detail a system controller implementing stereotype formulation according to one embodiment of the present invention. The controller hardware and programming 201 for system controller 200 may be implemented in stereotype server depicted in FIG. 1 or in similar devices. Alternatively, intermediate devices (not shown in FIG. 1) may be employed to deliver stereotypes formulated by system controller 200 to each of a plurality of devices having a recommendation system. Portions of the controller hardware, programming and input and output data 201 may be implemented in distributed fashion, with various portions being disposed within two or more devices.

However implemented, system controller 200 includes algorithms 202 for formulating stereotypes to be employed in initializing recommendation systems, including an initial cluster selection algorithm 203 and a clustering algorithm 204. A memory 206 accessible by the controller 201 contains viewing histories 206 for a sample population and, after formulation, stereotypes 207 derived from the viewing histories.

The viewing histories 206 contain a relatively large sample set for the relevant population within the viewing areas, and are assumed to contain programs categorized by two classes: “watched” and “not watched,” which may be determined, for instance, from tracking of actual viewing in conjunction with an electronic programming guide or the like, or by other means. Clusters are formed by K-means computations, by forming initial, randomly chosen clusters containing a predetermined number of viewing histories, and then incrementing the cluster until there is no further improvement in the recommendation performance for the cluster when tested on the same training set. The K-means clustering process thus improves the clusters in successive iterations. Since the data set for clustering includes examples with symbolic data, value difference metrics are employed to computer distances between examples and clusters. Further details regarding one clustering technique are set forth in U.S. patent application Ser. No. 10/014,195, entitled “METHOD AND APPARATUS FOR RECOMMENDING ITEMS OF INTEREST BASED ON STEREOTYPE PREFERENCES OF THIRD PARTIES” and filed Nov. 12, 2001, which is incorporated herein by reference.

As noted above, the clustering algorithm is very sensitive to the quality of the initial cluster set. Greater distance between initial clusters is more likely to result in stability of the clustering process, avoiding empty cluster that may occur when initial clusters are too close together. The clustering process may be seeded with randomly selected initial clusters, then the results analyzed utilizing metrics such as accuracy of the clustering process to select one set of clusters over another. Within such an approach, however, analysis of why one cluster is better than another is very difficult given the huge number of permutations possible for initial cluster sets.

In the present invention, therefore, a metric is devised to compare various initial cluster sets that might be input to the clustering algorithm. The metric is derived by summing all inter-cluster distances and normalizing by the number of summations used in arriving at the number. This metric may be employed to compare initial cluster sets with the intent of weeding out the “bad” initial cluster sets, permitting more effective analysis of cluster results.

The initial cluster selection algorithm 203 thus computes an average inter-cluster normalized distance for comparing various possible cluster sets. Assuming there are N+1 clusters within a set of possible initial clusters C0, C1, C2, . . . , CN−1, CN all satisfying the threshold requirement in terms of number of member viewing histories, the inter-cluster distance from each cluster to all other clusters is computed. For example, sum_C0 is the distance from the cluster C0 to all other clusters C1 through CN, or the distance from C0 to C1, plus the distance from C1 to C2, etc.; similarly, sum_C1 is the distance from cluster C1 to C0, plus the distance from cluster C1 to C2, etc. The distance measure may employ the Euclidean distance formula (square root of the sum of the squares of distances along each attribute axis) commonly used for k-means algorithms. Self-computation is preferably avoided (i.e., the distance from C0 to C0 is zero). The summation for each individual cluster is a summation over N values.

Once the inter-cluster distances from each cluster within a candidate set to all remaining clusters have been computed, the computed values for all individual clusters are summed. That is, the values sum_C0, sum_C1, sum_C2, . . . , sum_CN−1, sum_CN are aggregated, a summation over N+1 numbers. The total is then normalized for the number of values aggregated, with the overall computation being given by:

$${Avg}_{ICND} = \frac{1}{N ( N + 1 )} sum ( sum\_C0 , sum\_C1 , sum\_C2 , … , sum\_CN - 1 , sum\_CN ) \qquad ( 1 )$$

where Avg_{ICND} is the average inter-cluster normalized distance for the candidate cluster set. This computation is repeated for all candidate initial cluster sets, and the computed metric compared. The smaller this computed value is for a candidate initial cluster set, the closer the clusters are within that set, making that candidate set inferior for initialization of the clustering process over a candidate initial cluster set which has a larger average inter cluster normalized distance. Therefore the cluster sets having larger average inter-cluster normalized distances are selected to initialize the clustering process be for deriving stereotypes from a sample population of viewing histories.

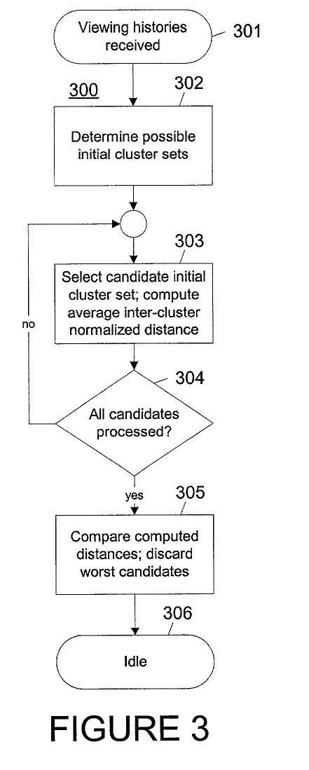

FIG. 3 is a high level flowchart for a process of selecting one or more possible initial cluster sets for a clustering process deriving stereotypes from a sample population of viewing histories according to one embodiment of the present invention. The process 300 begins with receiving a sample population viewing history (step 301). A determination of possible permutations of candidate initial cluster sets that would satisfy the threshold requirements for the number of samples within each cluster is first made (step 302).

A candidate initial cluster set is selected and the average inter-cluster normalized distance is computed for that candidate cluster set (step 303). The selection and computation process is then repeated for another candidate initial cluster set until all candidates have been processed (step 304). Once the average inter-cluster normalized distance has been computed for all possible initial cluster sets, the computed distances are compared and the worst candidate initial cluster sets are discarded (step 305). The process then becomes idle until another sample population of viewing histories is received.

The present invention is employed during determination of appropriate stereotypes employed to initially populate user profiles employed for recommendation systems. The stereotypes are determined by a clustering process trying various initial clusters, with the present invention allowing meaningful comparison of initial clusters to decide which are better for deriving stereotypes.

It is important to note that while the present invention has been described in the context of a fully functional system, those skilled in the art will appreciate that at least portions of the mechanism of the present invention are capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A system for evaluating initial cluster sets comprising:
a controller receiving a plurality of candidate initial cluster sets corresponding to a sample population of viewing histories and, for each candidate cluster set, computing a metric relating to a distance of each cluster within a particular candidate cluster set to every other cluster within that particular candidate cluster set.

2. The system according to claim 1, wherein the metric is a normalized average aggregate of distances between clusters within a candidate initial cluster set.

3. The system according to claim 2, wherein the metric is an average inter-cluster normalized distance equal to the sum of all aggregate inter-cluster distances for each cluster within a candidate initial cluster set normalized for a number of values aggregated.

4. The system according to claim 1, wherein the controller discards inferior candidate initial cluster sets based upon the metric.

5. The system according to claim 1, wherein the initial cluster sets to be employed within a clustering process deriving stereotypes to initially populate user profiles within a recommendation system from the sample population of viewing histories are selected based upon the metric.

6. A system for evaluating initial cluster sets comprising:
a memory containing a sample population of viewing histories and adapted to selectively receive one or more stereotypes; and
a controller communicably coupled to the memory and receiving the sample population of viewing histories, the controller
determining a plurality of candidate initial cluster sets corresponding to the sample population of viewing histories,
computing, for each candidate initial cluster set, a metric relating to a distance of each cluster within a particular candidate cluster set to every other cluster within that particular candidate cluster set,
selecting one or more candidate initial cluster sets based upon the metric, and
deriving one or more stereotypes from the sample population of viewing histories utilizing a clustering process initialized with the one or more selected candidate initial cluster sets.

7. The system according to claim 6, wherein the metric is a normalized average aggregate of distances between clusters within a candidate initial cluster set.

8. The system according to claim 7, wherein the metric is an average inter-cluster normalized distance equal to the sum of all aggregate inter-cluster distances for each cluster within a candidate initial cluster set normalized for a number of values aggregated.

9. The system according to claim 6, wherein the controller discards inferior candidate initial cluster sets based upon the metric.

10. The system according to claim 6, wherein the stereotypes derived by the clustering process are selectively employed to initially populate user profiles within a recommendation system.

11. A method for evaluating initial cluster sets comprising:
receiving a plurality of candidate initial cluster sets corresponding to a sample population of viewing histories; and
computing, for each candidate cluster set, a metric relating to a distance of each cluster within a particular candidate cluster set to every other cluster within that particular candidate cluster set.

12. The method according to claim 11, wherein the step of computing a metric relating to a distance of each cluster within a particular candidate cluster set to every other cluster within that particular candidate cluster set further comprises:
a normalized average aggregate of distances between clusters within a candidate initial cluster set.

13. The method according to claim 12, wherein the step of computing a metric relating to a distance of each cluster within a particular candidate cluster set to every other cluster within that particular candidate cluster set further comprises:
computing an average inter-cluster normalized distance equal to the sum of all aggregate inter-cluster distances for each cluster within a candidate initial cluster set normalized for a number of values aggregated.

14. The method according to claim 11, further comprising:
discarding inferior candidate initial cluster sets based upon the metric.

15. The method according to claim 11, further comprising:
selecting the initial cluster sets to be employed within a clustering process deriving stereotypes to initially populate user profiles within a recommendation system from the sample population of viewing histories based upon the metric.

16. A signal comprising:
at least one stereotype derived from a plurality of candidate initial cluster sets corresponding to a sample population of viewing histories by computing, for each candidate cluster set, a metric relating to a distance of each cluster within a particular candidate cluster set to every other cluster within that particular candidate cluster set.

17. The signal according to claim 16, wherein the metric is a normalized average aggregate of distances between clusters within a candidate initial cluster set.

18. The signal according to claim 17, wherein the metric is an average inter-cluster normalized distance equal to the sum of all aggregate inter-cluster distances for each cluster within a candidate initial cluster set normalized for a number of values aggregated.

19. The signal according to claim 16, wherein inferior candidate initial cluster sets identified based upon the metric are discarded during derivation of the at least one stereotype.

20. The signal according to claim 16, wherein the initial cluster sets employed within a clustering process deriving the at least one stereotype from the sample population of viewing histories are selected based upon the metric, wherein the at least one stereotype may be selectively employed to initially populate user profiles within a recommendation system.
